(19) United States
(12) Patent Application Publication
(10) Pub. No.: US 2024/0048087 A1
(43) Pub. Date: Feb. 8, 2024

(54) PHOTOVOLTAIC METAL ROOFING SYSTEM

(71) Applicant: AUO Corporation, HSIN-CHU (TW)

(72) Inventors: Li-Wei CHANG, HSIN-CHU (TW); Chia-Hsien HSUEH, HSIN-CHU (TW); HUng-Yang LIN, HSIN-CHU (TW)

(21) Appl. No.: 18/335,556

(22) Filed: Jun. 15, 2023

(30) Foreign Application Priority Data
Aug. 5, 2022 (TW) 111208503

(51) Int. Cl. H02S 20/23; H02S 40/36

(52) U.S. Cl. CPC H02S 20/23; H02S 40/36

(57) ABSTRACT

A photovoltaic metal roofing system includes a first corrugated sheet, a second corrugated sheet, a first solar panel and a second solar panel. The first corrugated sheet has a first bottom plate, a first bearing plate and a second bearing plate. The first bearing plate and the second bearing plate locate at two sides of the first bottom plate. The second corrugated sheet has a second bottom plate, a third bearing plate and a fourth bearing plate. The third bearing plate and the fourth bearing plate locate at two sides of the second bottom plate. The second bearing plate and the third bearing plate are bonded together and partially integrated to define a connecting structure. The first solar panel locates on the first bearing plate and the second bearing plate. The second solar panel locates on the third bearing plate and the fourth bearing plate.

### RELATED APPLICATIONS

### Technical Field

This application claims priority to Taiwanese Application Serial Number 111208503 filed Aug. 5, 2022, which is herein incorporated by reference.

### BACKGROUND

### Technical Field

The present disclosure relates to photovoltaic metal roofing systems.

### Description of Related Art

In general, the installation of traditional solar energy system usually requires laying corrugated sheets on the building (such as the roof) first. After a supporting frame is assembled on the corrugated sheets, the solar panel is then installed on the supporting frame, which increases the installation cost of laying the corrugated sheets and assembling the supporting frame. For example, this kind of configuration requires a lot of manpower and working time to drill holes on the corrugated sheets and the supporting frame and use a large number of screws and pressure blocks for locking at points. Thus, the material cost of installing the solar energy system is increased and the loading weight of the building is also increased. In addition, after the solar panel is installed, since the solar panel and the supporting frame are only locked at points by screws and pressure blocks, when a strong wind blows to the solar panel and the supporting frame, the negative wind pressure of the strong wind will easily damage the structural stability between the solar panel and the supporting frame, causing damage to the solar energy system.

### SUMMARY

A technical aspect of the present disclosure is to provide a photovoltaic metal roofing system.

According to an embodiment of the present disclosure, a photovoltaic metal roofing system includes a first corrugated sheet, a second corrugated sheet, a first solar panel and a second solar panel. The first corrugated sheet has a first bottom plate, a first bearing plate and a second bearing plate. The first bearing plate and the second bearing plate are located at two sides of the first bottom plate. The second corrugated sheet has a second bottom plate, a third bearing plate and a fourth bearing plate. The third bearing plate and the fourth bearing plate are located at two sides of the second bottom plate. The second bearing plate and the third bearing plate are bonded together and partially integrated to define a connecting structure. The first solar panel is located on the first bearing plate and the second bearing plate. The second solar panel is located on the third bearing plate and the fourth bearing plate.

In one or more embodiments of the present disclosure, one of the first bottom plate and the second bottom plate has a stiffening rib. A top surface of the stiffening rib is closer to one of the first solar panel and the second solar panel relative to a bottom surface of one of the first bottom plate and the second bottom plate.

In one or more embodiments of the present disclosure, one of the first bottom plate and the second bottom plate has a bearing portion. The bearing portion has two protruding ribs opposite to each other.

In one or more embodiments of the present disclosure, the photovoltaic metal roofing system further includes a supporting piece. The supporting piece is located between the two protruding ribs.

In one or more embodiments of the present disclosure, the photovoltaic metal roofing system further includes a plurality of double-sided structural tapes. The double-sided structural tape is located on a bottom surface of one of the first solar panel and the second solar panel.

In one or more embodiments of the present disclosure, a distance between one of the double-sided structural tapes and an edge of one of the first solar panel and the second solar panel is less than 7 mm.

In one or more embodiments of the present disclosure, each of the double-sided structural tapes has a first width ranging between 10 mm and 50 mm. A sum of the first widths of the double-sided structural tapes on one of the first solar panel and the second solar panel is ranged between 60 mm and 150 mm.

In one or more embodiments of the present disclosure, each of the first solar panels and the second solar panels has a second width. A ratio of the sum of the first widths to the second width is ranged between 5% and 42%.

In one or more embodiments of the present disclosure, a total area of the double-sided structural tapes located on one of the first solar panel and the second solar panel is larger than a product of a design wind pressure and an area of the corresponding one of the first solar panel and the second solar panel divided by an adhesive strength of the double-sided structural tapes.

In one or more embodiments of the present disclosure, the photovoltaic metal roofing system further includes an adhesive. The adhesive is located between the second bearing plate and the first solar panel and is located between the fourth bearing plate and the second solar panel.

In one or more embodiments of the present disclosure, one of the first corrugated sheet and the second corrugated sheet has a first top surface. One of the first solar panel and the second solar panel has a second top surface. The first top surface is higher than the second top surface. The first top surface and the second top surface have a height difference therebetween. The height difference is ranged between 3 mm and 40 mm.

According to an embodiment of the present disclosure, a photovoltaic metal roofing system includes a first corrugated sheet, a second corrugated sheet, two first solar panels and two second solar panels. The first corrugated sheet has a first bottom plate, a first bearing plate and a second bearing plate. The first bearing plate and the second bearing plate are located at two sides of the first bottom plate. The second corrugated sheet has a second bottom plate, a third bearing plate and a fourth bearing plate. The third bearing plate and the fourth bearing plate are located at two sides of the second bottom plate. The second bearing plate and the third bearing plate are bonded together and partially integrated to define a connecting structure. The two first solar panels are located on the first bearing plate and the second bearing plate. A first distance between the two first solar panels is ranged between 1 cm and 20 cm. Two second solar panels are located on the third bearing plate and the fourth bearing plate. A second distance between the two second solar panels is ranged between 1 cm and 20 cm.

In one or more embodiments of the present disclosure, a ratio of the first distance to a longitudinal length of one of the two first solar panels is ranged between 0.5% and 41%.

In one or more embodiments of the present disclosure, the first corrugated sheet has an overall height. The overall height is ranged between 3 cm and 15 cm. A ratio of the first distance to the overall height is ranged between 7% and 667%.

In one or more embodiments of the present disclosure, the photovoltaic metal roofing system further includes at least one safety module. The safety module is connected to at least one of the first solar panels and the second solar panels. The safety module is configured to optimize a flow of electricity and rapidly shut down a power.

In one or more embodiments of the present disclosure, the safety module is disposed on a bottom surface of one of the first solar panels and the second solar panels. An operating distance between the safety module and a nearest edge of the said one of the first solar panels and the second solar panels is ranged between 10 mm and 990 mm.

In one or more embodiments of the present disclosure, the safety module is disposed on a maintenance passage next to the first solar panels and the second solar panels. An operating distance between the safety module and a closest one of the first solar panels and the second solar panels is ranged between 10 mm and 2,000 mm.

In one or more embodiments of the present disclosure, the safety module is disposed inside a roof top structure. An operating distance between the safety module and an edge of the roof top structure is ranged between 10 mm and 2,000 mm.

According to an embodiment of the present disclosure, a photovoltaic metal roofing system includes a first corrugated sheet, a second corrugated sheet, a first solar panel, a second solar panel and two steel bodies. The first corrugated sheet has a first bottom plate, a first bearing plate and a second bearing plate. The first bearing plate and the second bearing plate are located at two sides of the first bottom plate. The second corrugated sheet has a second bottom plate, a third bearing plate and a fourth bearing plate. The third bearing plate and the fourth bearing plate are located at two sides of the second bottom plate. The second bearing plate and the third bearing plate are bonded together and partially integrated to define a connecting structure. The first solar panel is located on the first bearing plate and the second bearing plate. The second solar panel is located on the third bearing plate and the fourth bearing plate. The two steel bodies are locked to bottom surfaces of the first corrugated sheet and the second corrugated sheet. A steel structural interval between the two steel bodies is ranged between 50 cm and 275 cm.

In one or more embodiments of the present disclosure, a ratio of a longitudinal length of one of the first solar panel and the second solar panel to the steel structural interval is ranged between 25% and 561%.

In one or more embodiments of the present disclosure, the photovoltaic metal roofing system further includes at least one insulation panel. The insulation panel is located between the two steel bodies and underneath at least one of the first corrugated sheet and the second corrugated sheet.

In the aforementioned embodiments of the present disclosure, the second bearing plate of the first corrugated sheet and the third bearing plate of the second corrugated sheet of the photovoltaic metal roofing system are bonded together and partially integrated to define the connecting structure. The second bearing plate and the third bearing plate partially integrated can reinforce the structural stability between the first corrugated sheet and the second corrugated sheet, such that the structures of the first corrugated sheet and the second corrugated sheet are uneasy to be damaged when the first corrugated sheet and the second corrugated sheet are blown by a strong wind. Thus, the service life of the photovoltaic metal roofing system is increased. Moreover, the first corrugated sheet and the second corrugated sheet of the photovoltaic metal roofing system can be carried out at the factory in advance, and the first solar panel and the second solar panel can be respectively installed on the first corrugated sheet and the second corrugated sheet in advance. Since most of the installation work of the photovoltaic metal roofing system can be completed at the factory in advance, the working time for installing the photovoltaic metal roofing system on a building can be reduced. Thus, the overall operating efficiency can be improved and a saving of labor and installation cost can also be achieved at the same time.

### BRIEF DESCRIPTION OF THE DRAWINGS

The disclosure can be more fully understood by reading the following detailed description of the embodiments, with reference made to the accompanying drawings as follows:

FIG. 1 is a schematic view of a photovoltaic metal roofing system according to an embodiment of the present disclosure;

FIG. 2 is a partially enlarged view of the connecting structure of FIG. 1, in which the first solar panel and the second solar panel are omitted;

FIG. 3 is a bottom view of the first solar panel of FIG. 1;

FIG. 4A is a partially enlarged view of the first bearing plate of FIG. 1;

FIG. 4B is a partially enlarged view of the fourth bearing plate of FIG. 1;

FIG. 5 is a top view of a photovoltaic metal roofing system according to an embodiment of the present disclosure;

FIG. 6 is a schematic view of installing a photovoltaic metal roofing system according to an embodiment of the present disclosure;

FIG. 7 is a partially enlarged view of the supporting piece of FIG. 6 according to an embodiment of the present disclosure;

FIG. 8 is a partially enlarged view of the supporting piece of FIG. 6 according to another embodiment of the present disclosure;

FIG. 9 is a partially enlarged view of the auxiliary steel of FIG. 6;

FIGS. 10-14 are schematic views of a connecting structure according to other embodiments of the present disclosure;

FIG. 15 is a bottom view of a photovoltaic metal roofing system 100c according to a further embodiment of the present disclosure;

FIG. 16 is a top view of a photovoltaic metal roofing system according to another embodiment of the present disclosure; and

FIGS. 17-18 are schematic views of a photovoltaic metal roofing system according to a further embodiment of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

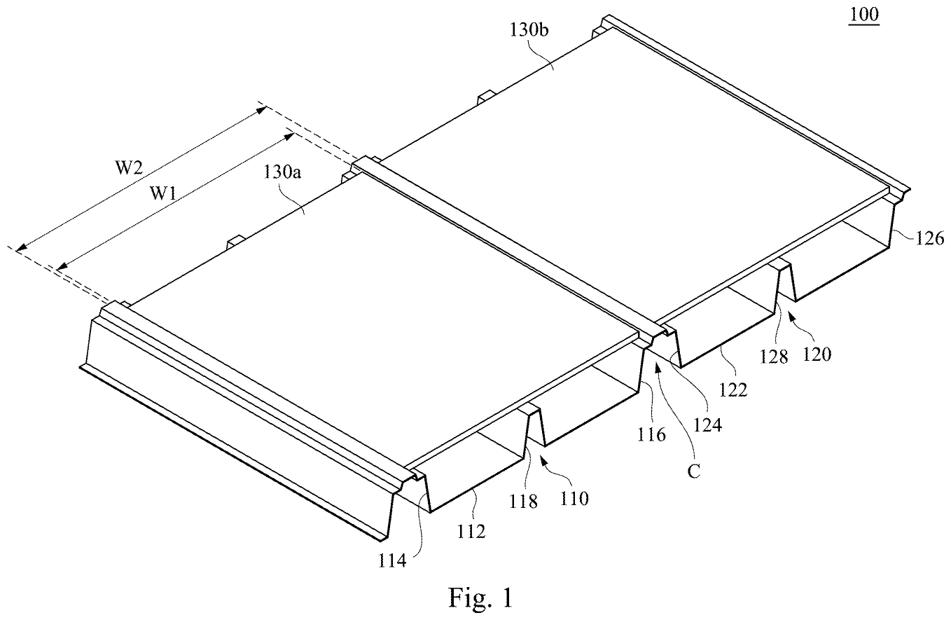

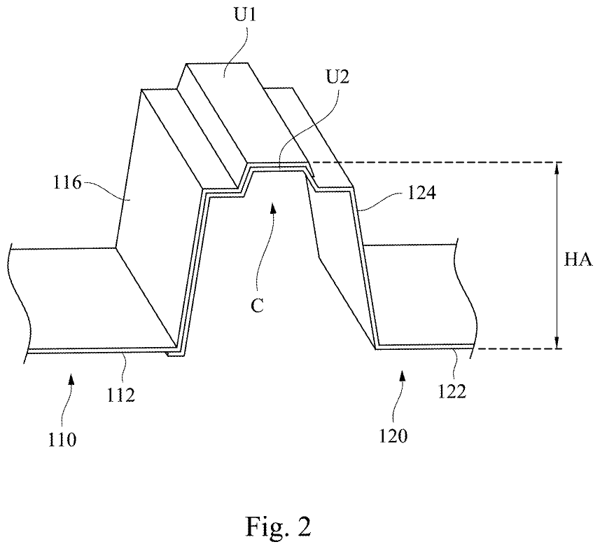

FIG. 1 is a schematic view of a photovoltaic metal roofing system 100 according to an embodiment of the present disclosure. FIG. 2 is a partially enlarged view of the connecting structure C of FIG. 1, in which the first solar panel 130a and the second solar panel 130b are omitted. Reference is made to FIG. 1 and FIG. 2. The photovoltaic metal roofing system 100 includes a first corrugated sheet 110, a second corrugated sheet 120, a first solar panel 130a and a second solar panel 130b. The first corrugated sheet 110 has a first bottom plate 112, a first bearing plate 114 and a second bearing plate 116. The first bearing plate 114 and the second bearing plate 116 of the first corrugated sheet 110 are located at two sides of the first bottom plate 112 of the first corrugated sheet 110.

On the other hand, the second corrugated sheet 120 of the photovoltaic metal roofing system 100 has the same shape as the first corrugated sheet 110. To be specific, the second corrugated sheet 120 of the photovoltaic metal roofing system 100 has a second bottom plate 122, a third bearing plate 124 and a fourth bearing plate 126. The third bearing plate 124 and the fourth bearing plate 126 of the second corrugated sheet 120 are located at two sides of the second bottom plate 122 of the second corrugated sheet 120. In some embodiments, the first bearing plate 114 of the first corrugated sheet 110 and the third bearing plate 124 of the second corrugated sheet 120 are similar in shape and appearance, the second bearing plate 116 of the first corrugated sheet 110 and the fourth bearing plate 126 of the second corrugated sheet 120 are similar in shape and appearance, while the second bearing plate 116 of the first corrugated sheet 110 and the third bearing plate 124 of the second corrugated sheet 120 are different in shape and appearance (please see FIG. 2).

It is worth to note that, the second bearing plate 116 of the first corrugated sheet 110 and the third bearing plate 124 of the second corrugated sheet 120 are bonded together. Moreover, the second bearing plate 116 and the third bearing plate 124 are partially integrated to define a connecting structure C. In details, in this embodiment, as shown in FIG. 2, the second bearing plate 116 of the first corrugated sheet 110 has an inverted U-shaped structure U1 while the third bearing plate 124 of the second corrugated sheet 120 has an inverted U-shaped structure U2 which defines the connecting structure C. The second bearing plate 116 is partially located on the third bearing plate 124 such that the inverted U-shaped structure U1 of the second bearing plate 116 covers on the inverted U-shaped structure U2 of the third bearing plate 124 in a fit manner, and the partial integration between the second bearing plate 116 and the third bearing plate 124 can reinforce the structural stability between the first corrugated sheet 110 and the second corrugated sheet 120. Moreover, glue or adhesive (not shown) can be added to the connecting structure C to reinforce the structure of the photovoltaic metal roofing system 100, and to reduce the risk of water leakage. To be specific, glue or adhesive (not shown) can be added between the side portions of the inverted U-shaped structure U1 and the side portions of the inverted U-shaped structure U2. Please be noted that, in this case of glue or adhesive (not shown) being added between the side portions, glue or adhesive is not present between the middle portion of the inverted U-shaped structure U1 of the second bearing plate 116 and the middle portion of the inverted U-shaped structure U2 of the third bearing plate 124.

In some embodiments, the first solar panel 130a is located on the first bearing plate 114 and the second bearing plate 116 of the first corrugated sheet 110. The second solar panel 130b is located on the third bearing plate 124 and the fourth bearing plate 126 of the second corrugated sheet 120. Furthermore, taking the first solar panel 130a as an example, as shown in FIG. 1, the first solar panel 130a has a width W1, which is practically ranged between 360 mm and 1,160 mm. On the other hand, a top of the first bearing plate 114 and a top of the second bearing plate 116 defines a width W2 therebetween, in which the width W2 is formed from original material of steel roll and is practically ranged between 400 mm and 1,200 mm. In general, the width W2 of the first corrugated sheet 110 is about 40 mm larger than the width W1 of the first solar panel 130a, such that the first solar panel 130a can be properly disposed on the first corrugated sheet 110.

In some embodiments, the first bottom plate 112 of the first corrugated sheet 110 and the second bottom plate 122 of the second corrugated sheet 120 respectively have at least one bearing portion 118 and at least one bearing portion 128. The first solar panel 130a and the second solar panel 130b are respectively located on the bearing portion 118 of the first corrugated sheet 110 and the bearing portion 128 of the second corrugated sheet 120.

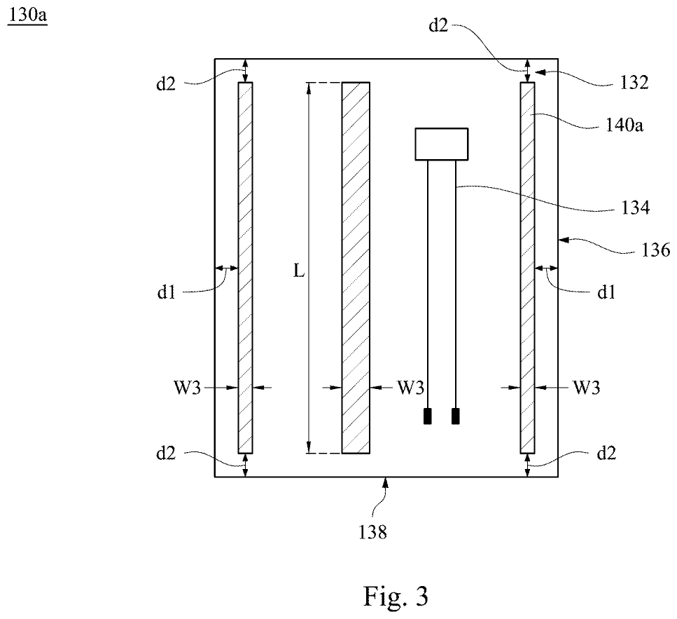

In addition, the first solar panel 130a, the first bottom plate 112 of the first corrugated sheet 110, the first bearing plate 114 of the first corrugated sheet 110 and the second bearing plate 116 of the first corrugated sheet 110 have an accommodation space therebetween. The second solar panel 130b, the second bottom plate 122 of the second corrugated sheet 120, the third bearing plate 124 of the second corrugated sheet 120 and the fourth bearing plate 126 of the second corrugated sheet 120 have another accommodation space therebetween. The accommodation spaces mentioned above can be regarded as spaces of heat dissipation for the first solar panel 130a and the second solar panel 130b. The spaces of heat dissipation can deliver away the heat produced by the first solar panel 130a and the second solar panel 130b during operation. Moreover, the cables 134 (to be described in details with regard to FIG. 3) of the first solar panel 130a (and the second solar panels 130b) can be integrated into the corresponding accommodation space.

To be specific, the second bearing plate 116 of the first corrugated sheet 110 and the third bearing plate 124 of the second corrugated sheet 120 of the photovoltaic metal roofing system 100 are bonded together and partially integrated to define the connecting structure C. The partial integration between the second bearing plate 116 and the third bearing plate 124 can reinforce the structural stability between the first corrugated sheet 110 and the second corrugated sheet 120, such that the structures of the first corrugated sheet 110 and the second corrugated sheet 120 are uneasy to be damaged when the first corrugated sheet 110 and the second corrugated sheet 120 are blown by a strong wind. Thus, the service life of the photovoltaic metal roofing system 100 can be increased. Moreover, the first corrugated sheet 110 and the second corrugated sheet 120 of the photovoltaic metal roofing system 100 can be installed at the factory in advance, and the first solar panel 130a and the second solar panel 130b can also be respectively installed on the first corrugated sheet 110 and the second corrugated sheet 120 in advance. Since most of the installation work of the photovoltaic metal roofing system 100 can be completed at the factory, the working time for installing the photovoltaic metal roofing system 100 on a building (such as a roof) can be effectively reduced. Thus, the overall operating efficiency can be improved and a saving of labor cost can also be achieved at the same time.

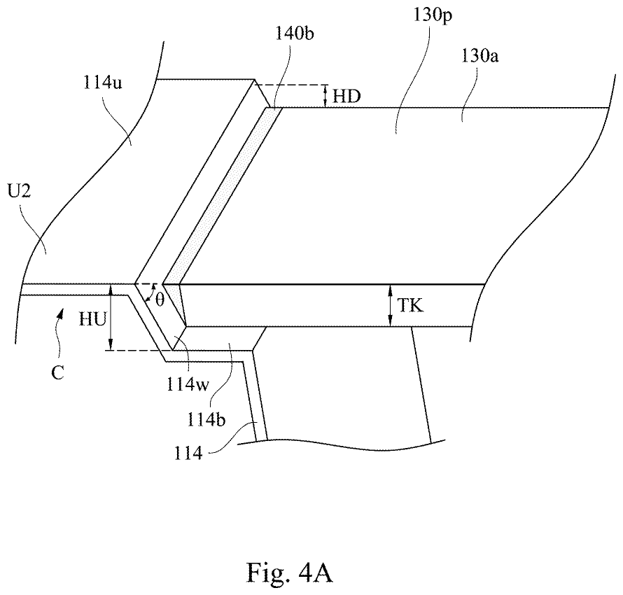

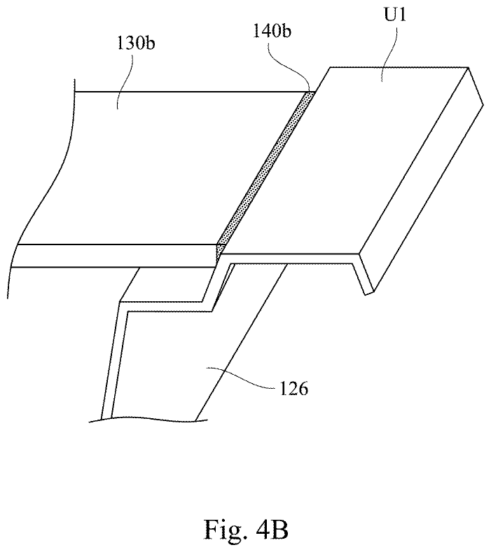

FIG. 3 is a bottom view of the first solar panel 130a of FIG. 1. Reference is made to FIG. 1 and FIG. 3. As shown in FIG. 3, the photovoltaic metal roofing system 100 further includes a plurality of double-sided structural tapes 140a. The quantity of the double-sided structural tape 140a shown in FIG. 3 is not intended to limit the present disclosure. The double-sided structural tapes 140a are located on a bottom surface 132 of the first solar panel 130a. A distance d1 between at least one of the double-sided structural tapes 140a and a first edge 136 of the first solar panel 130a is less than 7 mm. A distance d2 between each of the double-sided structural tapes 140a and a second edge 138 of the first solar panel 130a is less than 7 mm. For example, the first edge 136 can be located at one of the long edges of the first solar panel 130a, while the second edge 138 can be located at one of the short edges of the first solar panel 130a. When the first solar panel 130a is installed on the first corrugated sheet 110, the distance d1 between the first edge 136 of the first solar panel 130a and the corresponding one of the double-sided structural tapes 140a, and the distance d2 between the second edge 138 of the first solar panel 130a and the double-sided structural tapes 140a, can be regarded as adhesive filling regions, where an adhesive 140b can be filled thereon (to be described in details with regard to FIG. 4A), so as to further reinforce the structural stability between the first solar panel 130a and the first corrugated sheet 110.

To be more specific, in practice, the quantity of the double-sided structural tapes 140a for each of the first solar panels 130a and the second solar panels 130b should be two to six. For example, when the quantity of the double-sided structural tapes 140a for one of the first solar panels 130a is two, one of the two double-sided structural tapes 140a is adhered between the bottom surface 132 of the first solar panel 130a and a top surface of the first bearing plate 114, while the other one of the two double-sided structural tapes 140a is adhered between the bottom surface 132 of the first solar panel 130a and a top surface of the second bearing plate 116.

Furthermore, when there are three or more pieces of double-sided structural tapes 140a disposed on the bottom surface 132 of the first solar panel 130a, the two double-sided structural tapes 140a arranged outermost are respectively adhered to the top surface of the first bearing plate 114 and the top surface of the second bearing plate 116, as mentioned above. Meanwhile, the double-sided structural tape(s) 140a arranged between the two outermost double-sided structural tapes 140a, is (or are respectively) adhered to a top surface of a corresponding one of the bearing portions 118, provided that the quantity of the bearing portion 118 is equal to or more than the quantity of the double-sided structural tapes 140a disposed on the bottom surface 132 of the first solar panel 130a. In practice, a maximum quantity of the bearing portions 118 is four. On the other hand, actual to the actual situations, the quantity of the bearing portion 118 can be zero. However, this does not intend to limit the present disclosure.

In addition, to be specific, each of the double-sided structural tapes 140a has a width W3, in which the width W3 is practically ranged between 10 mm and mm while a sum of the widths W3 of all the double-sided structural tapes 140a disposed on the same piece of the first solar panel 130a is practically ranged between 60 mm and 150 mm. For example, where there are two double-sided structural tapes 140a disposed on the first solar panel 130a, the width W3 of each of the two double-sided structural tapes 140a should be equal to or larger than mm when the widths W3 are the same. For example, where there are six double-sided structural tapes 140a disposed on the first solar panel 130a, the width W3 of each of the two double-sided structural tapes 140a should be equal to or less than 25 mm when the widths W3 are the same. In practice, provided that the width W1 of the first solar panel 130a is practically ranged between 360 mm and 1,160 mm as mentioned above, a ratio of the sum of the widths W3 to the width W1 can be ranged between 5% (e.g., the width W1 is 1,160 mm, the sum of the widths W3 is 60 mm) and 42% (e.g., the width W1 is 360 mm, the sum of the widths W3 is 150 mm). For example, if the ratio of the sum of the widths W3 to the width W1 is more than 42%, the difficulty of the manufacturing process of the first corrugated sheet 110 (or the second corrugated sheet 120) will be increased. On the contrary, if the ratio of the sum of the widths W3 to the width W1 is less than 5%, the adhesive force between the first solar panel 130a and the first corrugated sheet 110 (or between the second solar panel 130b and the second corrugated sheet 120) will not be strong enough.

Mathematically speaking, for safety, a total area of the double-sided structural tapes 140a located on one of the first solar panel 130a and the second solar panel 130b should be larger than a product of a design wind pressure and an area of the corresponding one of the first solar panel 130a and the second solar panel 130b divided by an adhesive strength of the double-sided structural tapes 140a. The relation above is presented in the equation below:

$$total area of the double sided structural tapes \geq \frac{design wind pressure \times area of solar panel}{adhesive strength of the double sided structural tapes}$$

In other words, the capacity of the first solar panel 130a to resist against an uplift pressure due to strong wind is equal to the maximum allowable adhesive force exerted between the first solar panel 130a and the first corrugated sheet 110 divided by the area of the first solar panel 130a. As shown in FIG. 3, for example, the quantity of the double-sided structural tapes 140a disposed on the bottom surface 132 of the first solar panel 130a is three, and each of the double-sided structural tapes 140a has a length L. Taking the length to be 930 mm as an example, provided that the widths W3 of the two double-sided structural tapes 140a arranged outermost are respectively 15 mm while the width W3 of the double-sided structural tape 140a arranged between the two outermost double-sided structural tapes 140a is 30 mm, the total area of the three double-sided structural tapes 140a is equal to 55,800 mm² (=15 mm×930 mm+30 mm×930 mm+15 mm×930 mm). If the double-sided structural tapes 140a with maximum allowable adhesive force of 85 kPa are chosen, provided that the area of the first solar panel 130a is, for example, 669,600 mm² (=930 mm×720 mm), the capacity of the first solar panel 130a to resist against an uplift pressure due to strong wind will be (55,800 mm²×85 kPa)/669,600 mm²=7,083 Pa, which is larger than the wind pressure of about 2,400 Pa under a strong wind of level 17. In other words, with the configuration of dimensions of the first solar panel 130a and the double-sided structural tapes 140a as mentioned above, the photovoltaic metal roofing system 100 can resist against a strong wind of level 17.

In practical applications, the adhesive strength of the double-sided structural tapes 140a can be ranged between 30 kPa and 120 kPa. For example, if the adhesive strength of the double-sided structural tapes 140a is less than 30 kPa, the structural stability between the first solar panel 130a and the first corrugated sheet 110 (or between the second solar panel 130b and the second corrugated sheet 120) may not be strong enough. Meanwhile, if an excessive amount of the double-sided structural tapes 140a is used in order to resist against the design wind pressure, the material cost of the double-sided structural tapes 140a will be too high. On the other hand, if the adhesive strength of the double-sided structural tapes 140a is more than 120 kPa, the material cost of the double-sided structural tapes 140a will also be too high.

Similarly, the second solar panel 130b can be treated similarly as the first solar panel 130a as mentioned above, such that the second solar panel 130b can also be disposed with the double-sided structural tapes 140a thereon.

In some embodiments, the double-sided structural tapes 140a can be replaced by structural glues. In other words, structural glues are applied on the bottom surface 132 of the first solar panel 130a, and also the bottom surface of the second solar panel 130b.

Moreover, as shown in FIG. 3, the first solar panel 130a has a plurality of cables 134. The cables 134 can be integrated into the corresponding accommodation space of the photovoltaic metal roofing system 100. In practical applications, the cables 134 of different pieces of the first solar panels 130a (and also the second solar panels 130b) are connected in series as a bundle on the roof, and the working voltage of the first solar panels 130a (and also the second solar panels 130b) connected together should be less than the maximum allowable voltage of 1,500 V of the photovoltaic metal roofing system 100.

FIG. 4A is a partially enlarged view of the first bearing plate 114 of FIG. 1. FIG. 4B is a partially enlarged view of the fourth bearing plate 126 of FIG. 1. Reference is made to FIG. 4A and FIG. 4B. The photovoltaic metal roofing system 100 further includes an adhesive 140b. As shown in FIG. 4A, the adhesive 140b can be located between the first bearing plate 114 (and also the second bearing plate 116) and the edge (and also, according to the actual situation, the bottom surface 132) of the first solar panel 130a to secure the first solar panel 130a. As shown in FIG. 4B, the adhesive 140b can be located between the fourth bearing plate 126 and the edge (and also, according to the actual situation, the bottom surface) of the second solar panel 130b to secure the second solar panel 130b. Moreover, the adhesive 140b can seal the edges of the first solar panel 130a and the second solar panel 130b to provide an effect of protection.

Furthermore, as shown in FIG. 4A, a top surface 114u of the inverted U-shaped structure U2 is higher than a top surface 130p of the first solar panel 130a, such that the inverted U-shaped structure U2 can provide protection to the first solar panel 130a, especially during the transportation of the assembly of the first solar panel(s) 130a and the first corrugated sheet(s) 110. Moreover, the inverted U-shaped structure U2 can form a water-dispelling ladder structure with the first solar panel 130a, which is beneficial to the drainage of rain water. In addition, the top surface 114u of the inverted U-shaped structure U2 and the top surface 130p of the first solar panel 130a have a height difference HD therebetween. In this embodiment, the height difference HD is ranged between 3 mm and 40 mm, such that a cleaning robot can easily move across the inverted U-shaped structure U2 (or the inverted U-shaped structure U1). Moreover, the possibility of occurrence of capillarity is also reduced. If the height difference HD is less than 3 mm, the protection which the inverted U-shaped structure U1 provides to the first solar panel 130a will not be enough. Moreover, a water-dispelling ladder structure cannot be formed and the function of drainage will be reduced, which also reduces the protection provided by the glue or adhesive (not shown) added between the side portions of the inverted U-shaped structure U1 and the side portions of the inverted U-shaped structure U2. On the contrary, if the height difference HD is more than 40 mm, a cleaning robot may not be able to move across the inverted U-shaped structure U2 (or the inverted U-shaped structure U1).

In addition, as shown in FIG. 4A, for example, the first bearing plate 114 of the first corrugated sheet 110 has a bearing surface 114b from which the inverted U-shaped structure U2 is protruded and on which the first solar panel 130a is placed. In practical applications, the height HU of the top surface 114u of the inverted U-shaped structure U2 relative to the bearing surface 114s is practically ranged between 10 mm and 50 mm. Meanwhile, the thickness TK of the first solar panel 130a is practically ranged between 2 mm and 7 mm. Therefore, a ratio of the thickness TK to the height HU is ranged between 4% (e.g., the thickness TK is 2 mm, the height HU is 50 mm) and 70% (e.g., the thickness TK is 7 mm, the height HU is 10 mm). For example, if the ratio of the thickness TK to the height HU is more than 70%, when a cleaning robot moves over the inverted U-shaped structure U2, the cleaning robot will exert a heavy pressure on the first solar panel 130a (or the second solar panel 130b), which will result in cell micro-cracks of the first solar panel 130a (or the second solar panel 130b).

Moreover, as shown in FIG. 4A, the inverted U-shaped structure U1 has an inclined surface 114w connected to and relatively inclined to the top surface 114u and the bearing surface 114b. An angle θ between the top surface 114u and the inclined surface 114w is ranged between 50 degrees and 90 degrees, such that rain water on the inverted U-shaped structure U1 can be easily directed away from the inverted U-shaped structure U1, and the possibility of occurrence of capillarity is reduced. For example, if the angle θ is less than 50 degrees, rain water on the inverted U-shaped structure U1 will be uneasy to be directed away from the inverted U-shaped structure U1. On the contrary, if the angle θ is more than 90 degrees, the inverted U-shaped structure U1 is uneasy to be fitted on the inverted U-shaped structure U2.

It should be noted that, the connecting relations and the functions of the elements as mentioned above are not described again hereinafter. In the following description, other forms of the photovoltaic metal roofing system are illustrated.

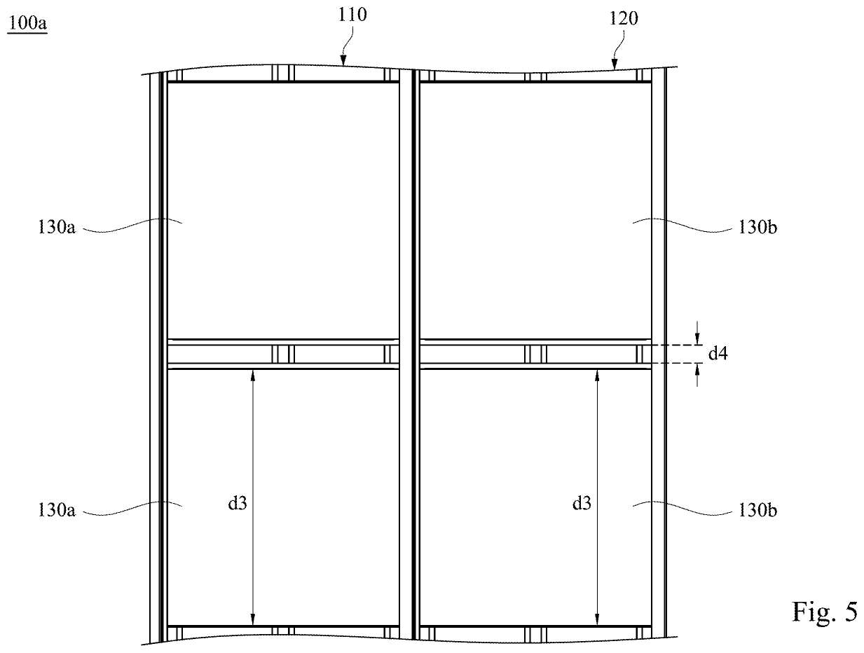

FIG. 5 is a top view of a photovoltaic metal roofing system 100a according to an embodiment of the present disclosure. The difference between the embodiment shown in FIG. 5 and the embodiment shown in FIG. 1 is that: the quantity of the first solar panel 130a of the photovoltaic metal roofing system 100a on the first corrugated sheet 110 and the quantity of the second solar panel 130b on the second corrugated sheet 120 are respectively two. In some embodiments, the longitudinal lengths d3 of the first solar panel 130a and the second solar panel 130b can be ranged between 49 cm and 199 cm, and a distance d4 between the two first solar panels 130a (or the two second solar panels 130b) can be ranged between 1 cm and 20 cm. In other words, a ratio of the distance d4 (e.g., between 1 cm and 20 cm) to the longitudinal length d3 (e.g., between 49 cm and 199 cm) can be ranged between 0.5% (e.g., the distance d4 is 1 cm, the longitudinal length d3 is 199 cm) and 41% (e.g., the distance d4 is 20 cm, the longitudinal length d3 is 49 cm). This can provide the effect of air ventilation and heat dissipation. Moreover, the distance d4 can be used as a screw locking region to reinforce the overall structure of the photovoltaic metal roofing system 100a. The distance d4 between the two first solar panels 130a (or the two second solar panels 130b) can provide the photovoltaic metal roofing system 100a with sufficient space of heat dissipation, in order to deliver away the heat produced by the first solar panels 130a and the second solar panels 130b during operation. Moreover, the distance d4 between the two first solar panels 130a (or the two second solar panels 130b) can be used as a screw locking region to improve the structural stability of the photovoltaic metal roofing system 100a. In addition, the distance d4 between the two first solar panels 130a (or the two second solar panels 130b) also provides space for maintenance.

Furthermore, reference is made to FIG. 2 and FIG. 5. As shown in FIG. 2, the second corrugated sheet 120 (and also the first corrugated sheet 110) has an overall height HA, in which the height HA is practically ranged between 3 cm and cm. Therefore, a ratio of the distance d4 (as shown in FIG. 5) to the overall height HA (as shown in FIG. 2) can be ranged between 7% (e.g., the distance d4 is 1 cm, the overall height HA is 15 cm) and 667% (e.g., the distance d4 is 20 cm, the overall height HA is 3 cm), which is efficient for heat dissipation. For example, if the ratio of the distance d4 to the overall height HA is more than 667%, the installation cost will be increased. On the contrary, if the ratio of the distance d4 to the overall height HA is less than 7%, the effect of heat dissipation will be reduced.

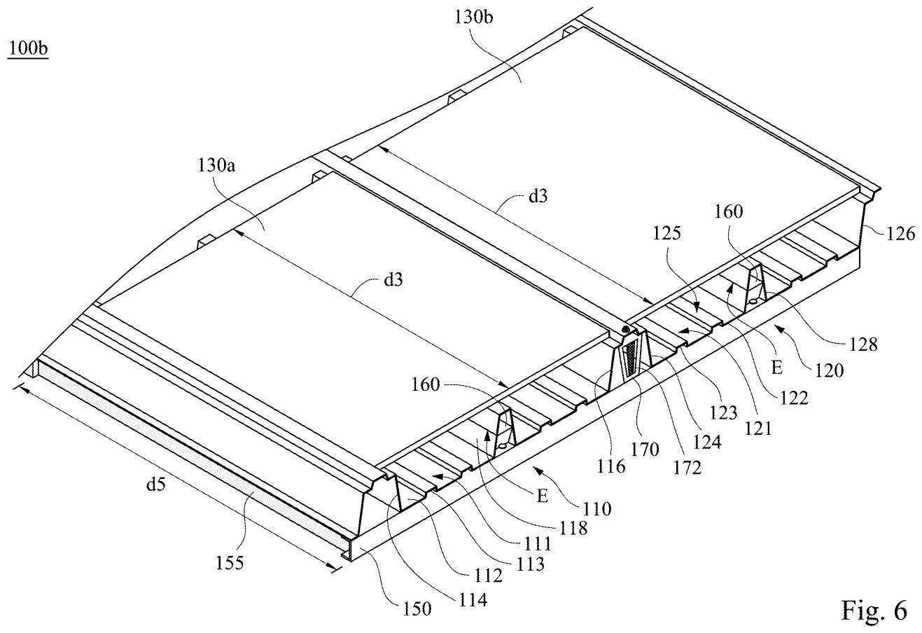

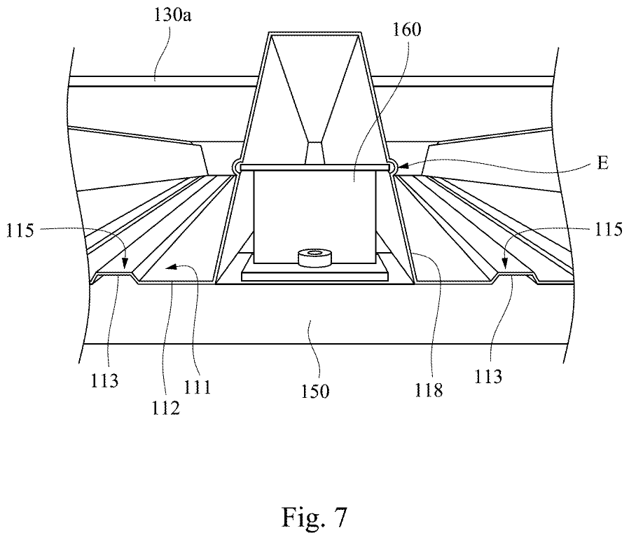

FIG. 6 is a schematic view of installing a photovoltaic metal roofing system 100b according to an embodiment of the present disclosure. FIG. 7 is a partially enlarged view of the supporting piece 160 of FIG. 6 according to an embodiment of the present disclosure. Reference is made to FIG. 6 and FIG. 7. The difference between the embodiment shown in FIG. 6 and the embodiment shown in FIG. 1 is that: the photovoltaic metal roofing system 100b further includes at least two steel bodies 150. The two steel bodies 150 can be locked to a bottom surface 111 of the first corrugated sheet 110 and a bottom surface 121 of the second corrugated sheet 120. Moreover, a steel structural interval (pitch) d5 between the two steel bodies 150 is ranged between 50 cm and 275 cm (e.g., 100 cm). A ratio of the steel structural interval d5 (e.g., between 50 cm and 275 cm) to the longitudinal length d3 (e.g., between 49 cm and 199 cm) of the first solar panel 130a and the second solar panel 130b can be ranged between 25% (e.g., the steel structural interval d5 is 50 cm, the longitudinal length d3 is 199 cm) and 561% (e.g., the steel structural interval d5 is 275 cm, the longitudinal length d3 is 49 cm). If this ratio of the steel structural interval d5 to the longitudinal length d3 is less than 25%, an excessive use of the steel bodies 150 will be resulted. On the contrary, if this ratio of the steel structural interval d5 to the longitudinal length d3 is more than 561%, the span of the first solar panel 130a and the second solar panel 130b on the steel bodies 150 will be too long and deformation of the first solar panel 130a or the second solar panel 130b may be resulted.

In some embodiments, as shown in FIGS. 6-7, the first bottom plate 112 of the first corrugated sheet 110 has a first stiffening rib 113. A top surface 115 of the first stiffening rib 113 is closer to the first solar panel 130a relative to a bottom surface 111 of the first bottom plate 112. As show in FIG. 6, the second bottom plate 122 of the second corrugated sheet 120 has a second stiffening rib 123. A top surface 125 of the second stiffening rib 123 is closer to the second solar panel 130b relative to a bottom surface 121 of the second corrugated sheet 120. The configuration of the first stiffening rib 113 and the second stiffening rib 123 can increase the bearing capacity of the first corrugated sheet 110 and the second corrugated sheet 120. Moreover, the first bottom plate 112 of the first corrugated sheet 110 and the second bottom plate 122 of the second corrugated sheet 120 respectively have a bearing portion 118 and a bearing portion 128. Each of the bearing portion 118 of the first bottom plate 112 and the bearing portion 128 of the second bottom plate 122 has two protruding ribs E opposite to each other. The photovoltaic metal roofing system 100b further includes a plurality of supporting pieces 160. One of the supporting pieces 160 is located between the two protruding ribs E of the bearing portion 118, and another one of the supporting pieces 160 is located between the two protruding ribs E of the bearing portion 128. The configuration of the supporting pieces 160 can reinforce the bearing capacity of the bearing portion 118 to the first solar panel 130a and the bearing capacity of the bearing portion 128 to the second solar panel 130b. As shown in FIG. 7, the supporting piece 160 is cut from a universal beam, and the supporting piece 160 is fixed on the steel body 150 by at least one screw penetrating through the lower flange of the universal beam and the steel body 150. Moreover, the upper flange of the universal beam is fixed between the protruding ribs E of the bearing portion 118.

Furthermore, as shown in FIG. 6, the photovoltaic metal roofing system 100b further includes at least one insulation panel 155. The insulation panel 155 is located between the two steel bodies 150. Moreover, the insulation panel 155 is underneath at least one of the first corrugated sheet 110 and the second corrugated sheet 120. The insulation panel 155 is configured to resist against heat and even fire for a period of 30 minutes to 1 hour, for example. In practical applications, the material of the insulation panel 155 can be rock wool, glass wool or polyisocyanurate (PIR).

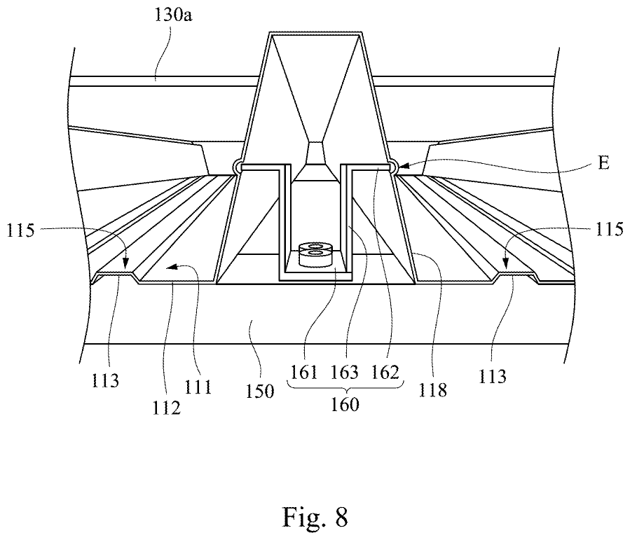

FIG. 8 is a partially enlarged view of the supporting piece 160 of FIG. 6 according to another embodiment of the present disclosure. In this embodiment, as shown in FIG. 8, the supporting piece 160 includes a lower plate 161, two upper plates 162 and two connecting plates 163. The lower plate 161 is supported on the steel body 150. Each of the connecting plates 163 is connected between the lower plate 161 and a corresponding one of the upper plates 162. The supporting piece 160 is fixed on the steel body 150 by at least one screw penetrating through the lower plate 161 and the steel body 150. Moreover, the upper plates 162 are fixed between the protruding ribs E of the bearing portion 118.

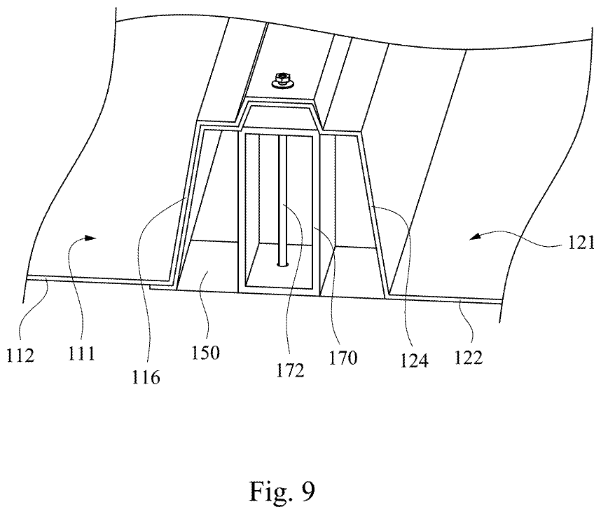

FIG. 9 is a partially enlarged view of the auxiliary steel 170 of FIG. 6. Reference is made to FIG. 6 and FIG. 9. An auxiliary steel 170 is locked to one of the steel bodies 150 by a screw 172. The auxiliary steel 170 can enhance the locking effect of screw 172, so as to increase the structural stability of the photovoltaic metal roofing system 100b. For example, by using the steel bodies 150 to install the photovoltaic metal roofing system 100b on a building (such as a roof), no traditional frame is required for the installation. Thus, the loading weight of the roof is reduced. Moreover, since most of the installation work of the photovoltaic metal roofing system 100b can be completed at the factory in advance, the working time for installing the photovoltaic metal roofing system 100b on a roof can be reduced. Thus, the overall operating efficiency can be improved and a saving of labor and installation cost can also be achieved at the same time.

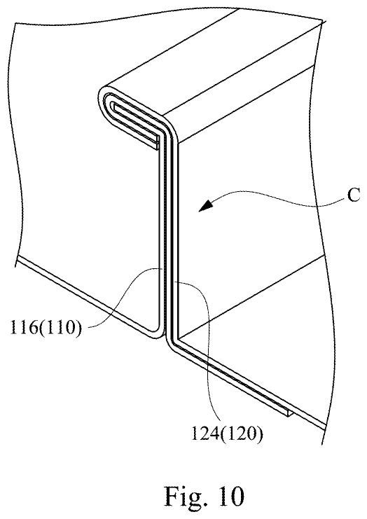

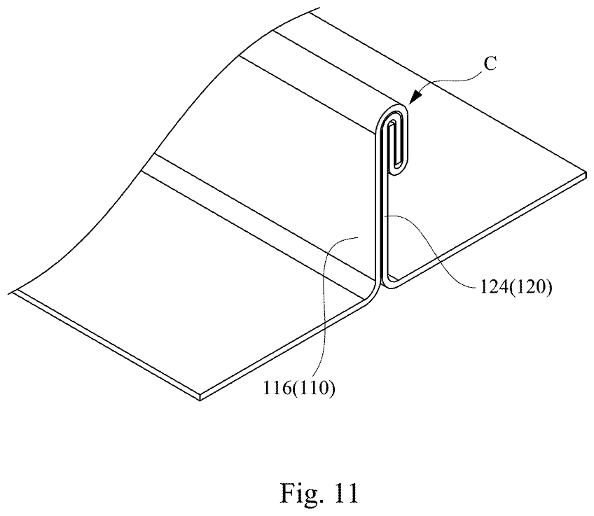

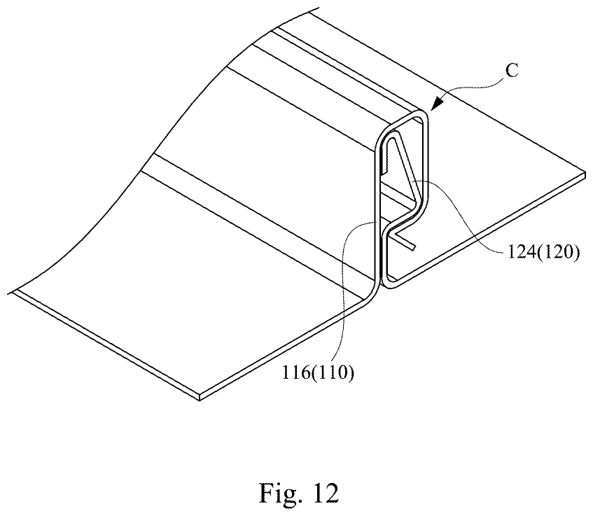

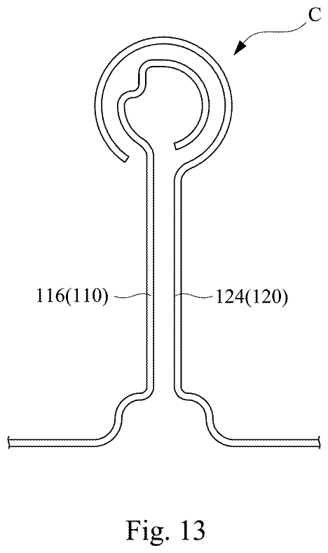

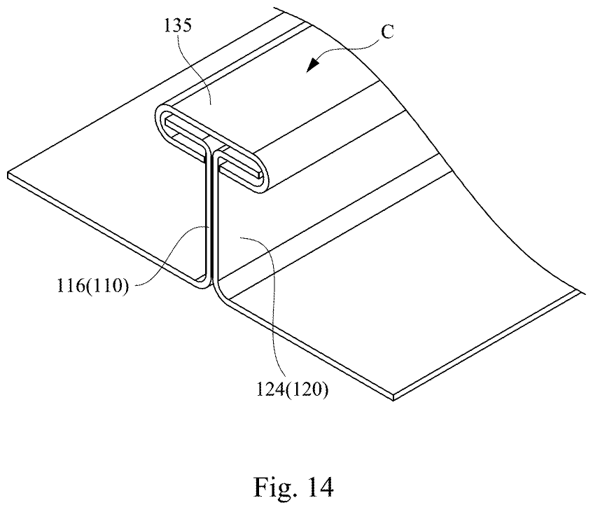

Reference is made to FIGS. 10-14. FIGS. 10-14 are schematic views of a connecting structure C according to other embodiments of the present disclosure. According to actual situations, the shape of the connecting structure C defined by the second bearing plate 116 of the first corrugated sheet 110 and the third bearing plate 124 of the second corrugated sheet 120 can be different from that of the embodiment described above. Please see the examples as shown in FIGS. 10-14. As shown in FIG. 10, the connecting structure C is at least partially bent by 90 degrees. As shown in FIG. 11, the connecting structure C is at least partially bent by 180 degrees. As shown in FIG. 12, the second bearing plate 116 is at least partially formed as an R-shape, and the third bearing plate 124 is at least partially accommodated in the space enclosed by the R-shaped portion of the second bearing plate 116. As shown in FIG. 13, the second bearing plate 116 is at least partially formed as an O-shape, and the third bearing plate 124 is at least partially accommodated in the space enclosed by the O-shaped portion of the second bearing plate 116. As shown in FIG. 14, the second bearing plate 116 and the third bearing plate 124 are at least partially bent to form a T-shape together, and an enclosing structure 135 at least partially encloses the T-shaped structure of the second bearing plate 116 and the third bearing plate 124 to secure the structural stability of the connecting structure C as a T-shaped structure.

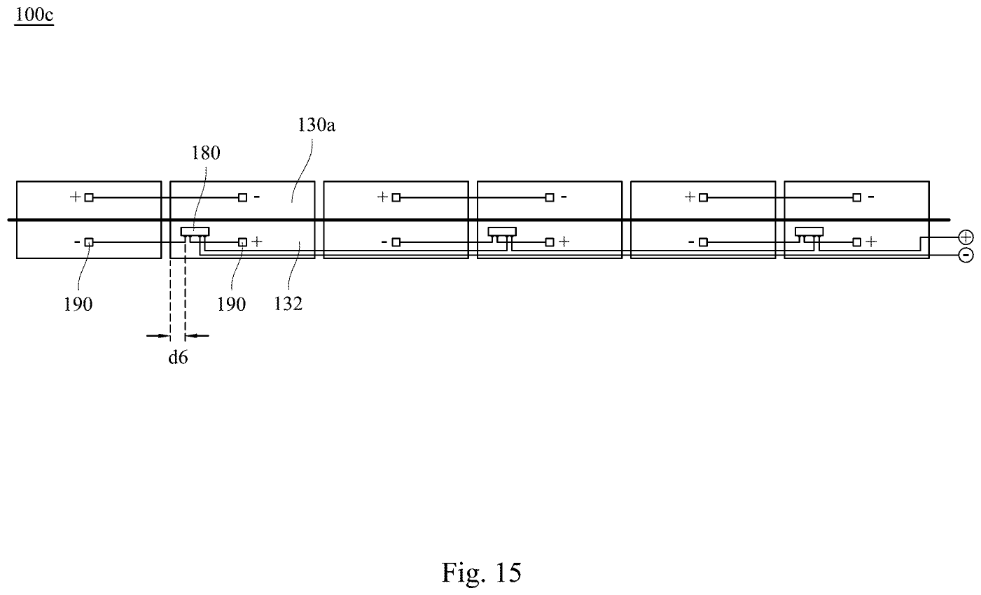

FIG. 15 is a bottom view of a photovoltaic metal roofing system 100c according to a further embodiment of the present disclosure. In this embodiment, the photovoltaic metal roofing system 100c further includes a plurality of safety modules 180. To be specific, each of the safety modules 180 includes an optimizer and a rapid shutdown (RSD). The optimizer is configured to optimize the flow of electricity. The RSD is configured to rapidly shut down the power of photovoltaic metal roofing system 100c in case there is a fire. As shown in FIG. 15, each of the safety modules 180 is electrically connected to one of the first solar panels 130a (or the second solar panels 130b) and is disposed on the bottom surface 132 of one of the first solar panels 130a (or the bottom surface of one of the second solar panels 130b). Each of the safety modules 180 is further electrically connected with two cable boxes 190 respectively disposed on the first solar panel 130a on which the safety module 180 is disposed and an adjacent one of the first solar panels 130a. An operating distance d6 between each of the safety modules 180 and the nearest edge of the first solar panel 130a on which the safety module 180 is disposed is practically ranged between 10 mm and 990 mm. For example, if the operating distance d6 is more than 990 mm, an extra maintenance hole (not shown) should be prepared for a worker to carry out maintenance. On the contrary, if the operating distance d6 is less than 10 mm, the risk of physical damage to the safety module 180 will be increased.

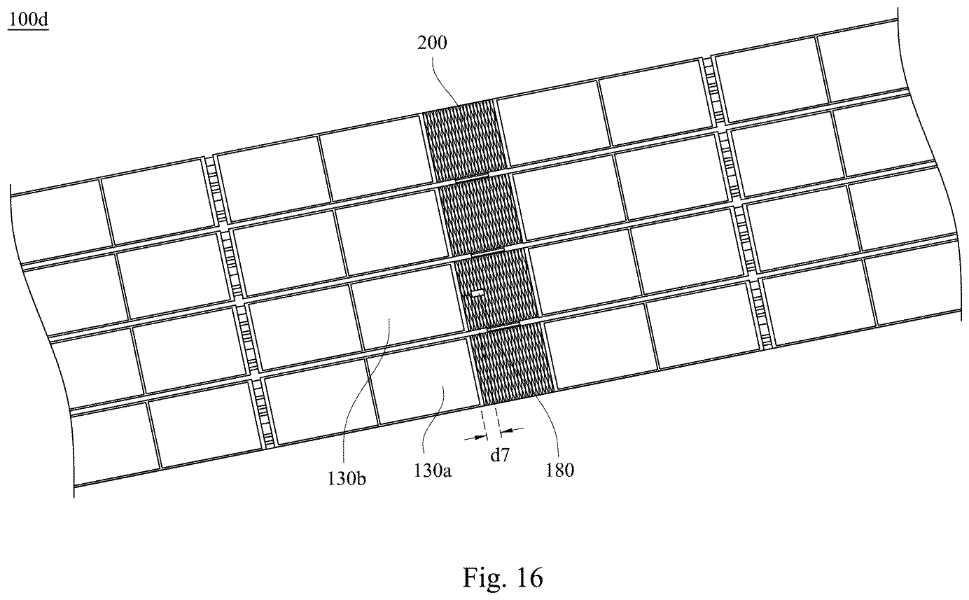

FIG. 16 is a top view of a photovoltaic metal roofing system 100d according to another embodiment of the present disclosure. In this embodiment, as shown in FIG. 16, the safety module 180 is disposed on a maintenance passage 200 next to the first solar panels 130a and the second solar panels 130b and is electrically connected with at least one of the first solar panels 130a and the second solar panels 130b. Moreover, an operating distance d7 between the safety module 180 and the closest one of the first solar panels 130a and the second solar panels 130b is practically ranged between 10 mm and 2,000 mm. For example, if the operating distance d7 is more than 2,000 mm, a waste of space for placing the first solar panels 130a or the second solar panels 130b will be resulted. On the contrary, if the operating distance d7 is less than 10 mm, the risk of physical damage to the safety module 180 will be increased.

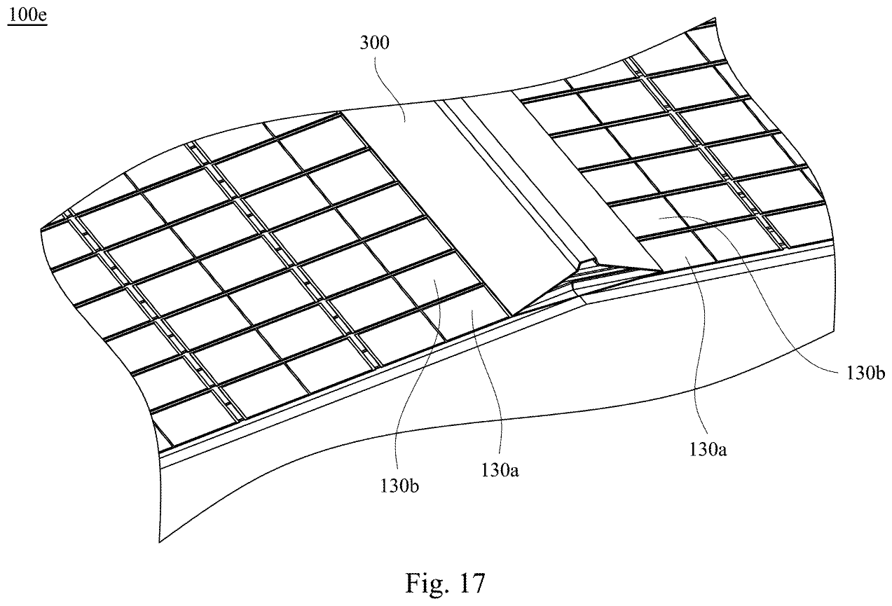

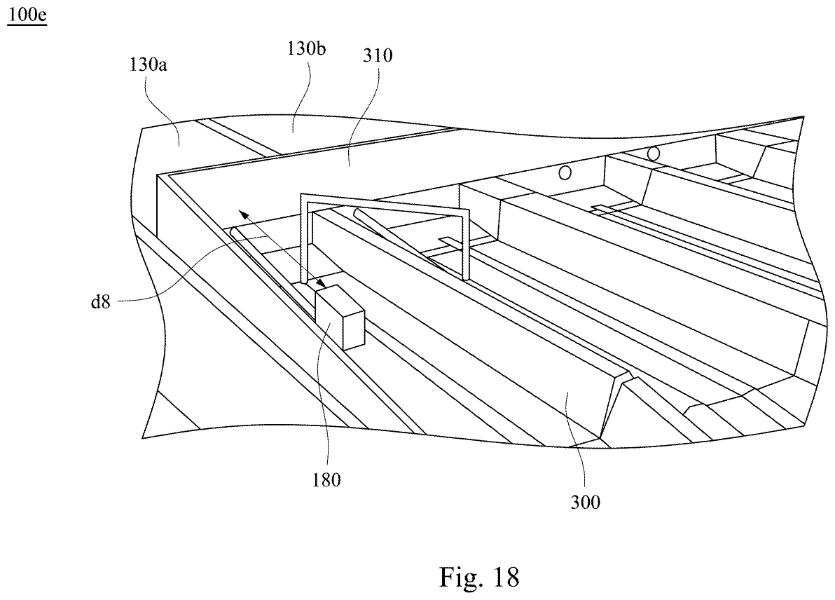

FIGS. 17-18 are schematic views of a photovoltaic metal roofing system 100e according to a further embodiment of the present disclosure. As shown in FIG. 17, the first solar panels 130a and the second solar panels 130b are disposed on the opposite sides of a roof top structure 300. In this embodiment, as shown in FIG. 18, the safety module 180 is disposed inside the roof top structure 300 and is electrically connected with at least one of the first solar panels 130a and the second solar panels 130b. Moreover, an operating distance d8 between the safety module 180 and an edge 310 of the roof top structure 300 is practically ranged between 10 mm and 2,000 mm. For example, if the operating distance d8 is more than 2,000 mm, a waste of space for placing the first solar panels 130a or the second solar panels 130b will be resulted. On the contrary, if the operating distance d8 is less than 10 mm, the risk of physical damage to the safety module 180 will be increased.

In the aforementioned embodiments of the present disclosure, the second bearing plate of the first corrugated sheet and the third bearing plate of the second corrugated sheet of the photovoltaic metal roofing system are bonded together and partially integrated to define the connecting structure. The partial integration between the second bearing plate and the third bearing plate can reinforce the structural stability between the first corrugated sheet and the second corrugated sheet, such that the structures of the first corrugated sheet and the second corrugated sheet are uneasy to be damaged when the first corrugated sheet and the second corrugated sheet are blown by a strong wind. Thus, the service life of the photovoltaic metal roofing system is increased. Moreover, the first corrugated sheet and the second corrugated sheet of the photovoltaic metal roofing system can be carried out at the factory in advance, and the first solar panel and the second solar panel can also be respectively installed on the first corrugated sheet and the second corrugated sheet in advance. Since most of the installation work of the photovoltaic metal roofing system can be completed at the factory in advance, the working time for installing the photovoltaic metal roofing system on a building can be reduced. Thus, the overall operating efficiency can be improved and a saving of labor and installation cost can also be achieved at the same time.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A photovoltaic metal roofing system, comprising:
a first corrugated sheet having a first bottom plate, a first bearing plate and a second bearing plate, the first bearing plate and the second bearing plate being located at two sides of the first bottom plate;
a second corrugated sheet having a second bottom plate, a third bearing plate and a fourth bearing plate, the third bearing plate and the fourth bearing plate being located at two sides of the second bottom plate, the second bearing plate and the third bearing plate being bonded together and partially integrated to define a connecting structure;
a first solar panel located on the first bearing plate and the second bearing plate; and
a second solar panel located on the third bearing plate and the fourth bearing plate.

2. The photovoltaic metal roofing system of claim 1, wherein one of the first bottom plate and the second bottom plate has a stiffening rib, a top surface of the stiffening rib is closer to one of the first solar panel and the second solar panel relative to a bottom surface of one of the first bottom plate and the second bottom plate.

3. The photovoltaic metal roofing system of claim 1, wherein one of the first bottom plate and the second bottom plate has a bearing portion, the bearing portion has two protruding ribs opposite to each other.

4. The photovoltaic metal roofing system of claim 3, further comprising:
a supporting piece located between the two protruding ribs.

5. The photovoltaic metal roofing system of claim 1, further comprising:
a plurality of double-sided structural tapes located on a bottom surface of one of the first solar panel and the second solar panel.

6. The photovoltaic metal roofing system of claim 5, wherein a distance between one of the double-sided structural tapes and an edge of one of the first solar panel and the second solar panel is less than 7 mm.

7. The photovoltaic metal roofing system of claim 5, wherein each of the double-sided structural tapes has a first width ranging between 10 mm and 50 mm, a sum of the first widths of the double-sided structural tapes on one of the first solar panel and the second solar panel is ranged between 60 mm and 150 mm.

8. The photovoltaic metal roofing system of claim 7, wherein each of the first solar panels and the second solar panels has a second width, a ratio of the sum of the first widths to the second width is ranged between 5% and 42%.

9. The photovoltaic metal roofing system of claim 5, wherein a total area of the double-sided structural tapes located on one of the first solar panel and the second solar panel is larger than a product of a design wind pressure and an area of the corresponding one of the first solar panel and the second solar panel divided by an adhesive strength of the double-sided structural tapes.

10. The photovoltaic metal roofing system of claim 1, further comprising:
an adhesive located between the second bearing plate and the first solar panel and located between the fourth bearing plate and the second solar panel.

11. The photovoltaic metal roofing system of claim 1, wherein one of the first corrugated sheet and the second corrugated sheet has a first top surface, one of the first solar panel and the second solar panel has a second top surface, the first top surface is higher than the second top surface, the first top surface and the second top surface have a height difference therebetween, the height difference is ranged between 3 mm and 40 mm.

12. A photovoltaic metal roofing system, comprising:
a first corrugated sheet having a first bottom plate, a first bearing plate and a second bearing plate, the first bearing plate and the second bearing plate being located at two sides of the first bottom plate;
a second corrugated sheet having a second bottom plate, a third bearing plate and a fourth bearing plate, the third bearing plate and the fourth bearing plate being located at two sides of the second bottom plate, the second bearing plate and the third bearing plate being bonded together and partially integrated to define a connecting structure;
two first solar panels located on the first bearing plate and the second bearing plate, a first distance between the two first solar panels being ranged between 1 cm and 20 cm; and
two second solar panels located on the third bearing plate and the fourth bearing plate, a second distance between the two second solar panels being ranged between 1 cm and 20 cm.

13. The photovoltaic metal roofing system of claim 12, wherein a ratio of the first distance to a longitudinal length of one of the two first solar panels is ranged between 0.5% and 41%.

14. The photovoltaic metal roofing system of claim 12, wherein the first corrugated sheet has an overall height, the overall height is ranged between 3 cm and 15 cm, a ratio of the first distance to the overall height is ranged between 7% and 667%.

15. The photovoltaic metal roofing system of claim 12, further comprising:
at least one safety module connected to at least one of the first solar panels and the second solar panels, the safety module being configured to optimize a flow of electricity and rapidly shut down a power.

16. The photovoltaic metal roofing system of claim 15, wherein the safety module is disposed on a bottom surface of one of the first solar panels and the second solar panels, an operating distance between the safety module and a nearest edge of the said one of the first solar panels and the second solar panels is ranged between 10 mm and 990 mm.

17. The photovoltaic metal roofing system of claim 15, wherein the safety module is disposed on a maintenance passage next to the first solar panels and the second solar panels, an operating distance between the safety module and a closest one of the first solar panels and the second solar panels is ranged between 10 mm and 2,000 mm.

18. The photovoltaic metal roofing system of claim 15, wherein the safety module is disposed inside a roof top structure, an operating distance between the safety module and an edge of the roof top structure is ranged between 10 mm and 2,000 mm.

19. A photovoltaic metal roofing system, comprising:
a first corrugated sheet having a first bottom plate, a first bearing plate and a second bearing plate, the first bearing plate and the second bearing plate being located at two sides of the first bottom plate;
a second corrugated sheet having a second bottom plate, a third bearing plate and a fourth bearing plate, the third bearing plate and the fourth bearing plate being located at two sides of the second bottom plate, the second bearing plate and the third bearing plate being bonded together and partially integrated to define a connecting structure;
a first solar panel located on the first bearing plate and the second bearing plate;
a second solar panel located on the third bearing plate and the fourth bearing plate; and
two steel bodies locked to bottom surfaces of the first corrugated sheet and the second corrugated sheet, a steel structural interval between the two steel bodies being ranged between 50 cm and 275 cm.

20. The photovoltaic metal roofing system of claim 19, wherein a ratio of a longitudinal length of one of the first solar panel and the second solar panel to the steel structural interval is ranged between 25% and 561%.

21. The photovoltaic metal roofing system of claim 19, further comprising:
at least one insulation panel located between the two steel bodies and underneath at least one of the first corrugated sheet and the second corrugated sheet.
